(19) United States
(12) Patent Application Publication
(10) Pub. No.: US 2023/0074877 A1
(43) Pub. Date: Mar. 9, 2023

(54) GLAZING HAVING AN RFID TRANSPONDER

(71) Applicant: SAINT-GOBAIN GLASS FRANCE, COURBEVOIE (FR)

(72) Inventors: Alicia DRÖGE, AACHEN (DE); Thomas HOLTSTIEGE, SCHWELM (DE); Christian EFFERTZ, AACHEN (DE); Christopher MARJAN, AACHEN (DE)

(21) Appl. No.: 17/797,992

(22) PCT Filed: Feb. 5, 2021
(86) PCT No.: PCT/EP2021/052732

§ 371 Date: Aug. 5, 2022

(30) Foreign Application Priority Data
Feb. 7, 2020 (EP) 20156085.1

(51) Int. Cl. H01Q 13/10; E06B 3/66; E06B 3/54

(52) U.S. Cl. CPC H01Q 13/10; E06B 3/66; E06B 3/5454; H01Q 1/2208

(57) ABSTRACT

A glazing includes a frame made of a metallic first frame element, a metallic second frame element, and a polymeric third frame element connecting the frame elements at least in some sections, a glazing unit arranged in the frame, and a RFID transponder having a dipole antenna or a slot antenna and an operating frequency f, wherein the frame surrounds the end faces of the glazing unit and, at the same time, covers the RFID transponder in the viewing direction through the glazing unit, a distance D between the center of the dipole antenna or the center of the slot antenna and the nearest adjacent corner of the glazing unit is from 40% to 100% of a vacuum wavelength lambda corresponding to the operating frequency f, and the RFID transponder is arranged on an interior-side surface of the frame.

The invention relates to a glazing with a metallic frame and a glazing unit inserted into the frame, preferably an insulating glazing unit, wherein the frame surrounds the edges of the glazing unit and, at the same time, covers at least one RFID transponder. The RFID transponder can be used as an identification element. The glazing is in particular intended to form a façade glazing, a window, a door, or an interior partition with a corresponding structure.

RFID transponders are used in a variety of ways for the identification of objects, for example, of solid or composite solid material panels, as is known, for example, from EP 2 230 626 A1.

Modern windows, doors, and façade glazings, at least for use in northern and temperate latitudes, are usually produced using prefabricated insulating glazing units (IGUs) that have the aforementioned structure, but, optionally, can include even more than two glass panes in the combination. Such insulating glazing units are mass-produced, shipped, and also independently marketed products that should be uniquely identifiable on their way to an end product and possibly even during maintenance and servicing.

It is already known to provide insulating glazing units with identifying markings, and certain requirements of manufacturers and users have arisen in the related practice:
The identifying marking should not be visible either from the inside or from the outside of the finished window, door, or façade.
The marking should be “readable” from a distance of at least 30 cm.
The marking should be as forgery-proof as possible, i.e., should not be readily possible to overwrite or to copy.

The effectiveness of conventional identifying markings, such as barcodes or QR codes, is based on their visibility, which, for insulating glazing units, means at least one limitation under the first aspect above. Meeting the second requirement is also difficult. Protection against copying cannot be guaranteed since barcodes and QR codes can be photographed.

It has also been proposed to provide insulating glazing units with “electronic” identifiers, in particular identifiers readable via radio, so-called “RFID transponders”. Such insulating glazing units are, for example, disclosed in WO 00/36261 A1, WO 2019/219460 A1, WO 2019/219462 A1, or WO 2007/137719 A1.

Such an RFID transponder can be protected with a password such that it cannot be overwritten or its radio capability destroyed without considerable effort.

Certain types of window and door frames, but especially façade constructions in which insulating glazing units are installed are made completely or at least partially of a metal (aluminum, steel . . . ), which interrupts or at least greatly attenuates the passage of radio waves from or to the RFID transponder on the insulating glazing unit. For this reason, meeting the second requirement above has, in particular, proved difficult. Known insulating glazing units provided with RFID transponders are, consequently, not readily usable with metal frame constructions. This reduces the potential range of application of glazing units identified in this manner and thus the acceptance of these marking solutions by manufacturers and users.

The object of the invention is, consequently, to provide an improved glazing having a glazing unit and a frame construction, wherein the frame construction is made, at least to a considerable extent, of a metal and also ensures meeting the aforementioned requirements in such installation situations.

This object is accomplished according to a first aspect of the invention by a glazing with the features of claim 1. Expedient further developments of the idea of the invention are the subject matter of the respective dependent claims.

The invention comprises a glazing, in particular a façade glazing, a window, a door, or an interior partition, comprising:
a frame made of a metallic first frame element, a metallic second frame element, and a polymeric third frame element connecting the frame elements at least in some sections and preferably completely perimetrally, and
a glazing unit arranged in the frame, in particular an insulating glazing unit,
at least one RFID transponder having a dipole antenna or a slot antenna and an operating frequency f and a corresponding vacuum wavelength lambda, wherein
the frame surrounds the end faces of the glazing unit and, at the same time, covers the RFID transponder(s) in the viewing direction through the glazing unit, and
a distance D between a center of the dipole antenna or a center of the slot antenna and a nearest adjacent corner of the glazing unit is from 40% to 100% of the vacuum wavelength lambda.

In an advantageous embodiment of the glazing according to the invention, the distance D is from 60% to 100% of the vacuum wavelength lambda and in particular from 70% to 90% of the vacuum wavelength lambda.

The vacuum wavelength lambda is derived from the vacuum speed of light c0 divided by the operating frequency f of the RFID transponder, i.e., lambda=c0/f.

The glazing, i.e., in particular the frame and the glazing unit, are polygonal, (i.e., having three or more corners) and, in particular, are rectangular or square.

The glazing unit has two large primary surfaces (front and back), which are connected via narrow, perimetral end faces. The corners of the glazing unit are formed by the meeting of two end faces forming an angle. The same applies to the frame surrounding the glazing unit.

The frame surrounds the end face of the glazing unit, preferably in the shape of a U, and, at the same time, covers the RFID transponder(s) in the viewing direction through the glass pane. Usually, the legs of the first and second frame elements are designed such that, in an insulating glazing, they at least completely cover the outer region and the spacer frame in the viewing direction through the glazing unit.

In another advantageous embodiment of the glazing according to the invention, the frame surrounds all end faces of a glazing unit in the form of a frame, in other words, the frame is arranged completely around the glazing unit and is, in particular, self-contained. The frame is, in particular, implemented directly around one glazing unit in each case.

In another advantageous embodiment, the distance A between the end faces of the glazing unit and the interior-side end faces of the frame is from 0 mm to 50 mm, preferably 0.5 mm to 50 mm, particularly preferably from 1 mm to 20 mm, and in particular from 3 mm to 8 mm. The interior-side end face of the frame is the surface in the interior of the frame that is directly opposite the end face of the glazing unit.

The invention includes the idea of taking into account the fundamentally unfavorable outgoing and incoming radiation conditions for radio waves in a metallic frame of a glazing by means of special coupling in and coupling out of the RFID signal. Unexpectedly, particularly good results were achieved when the RFID transponder(s) were arranged in the vicinity of the corners of the glazing unit and, thus, when installed in the frame, were arranged in the vicinity of the corners of the frame. In this respect (in the case of RFID transponders with dipole antennas). distances D between the center of the dipole antenna or (in the case of RFID transponders with slot antennas) between the center of the slot antenna and the nearest adjacent corner of the glazing unit in the range from 40% to 100% of the vacuum wavelength lambda, particularly preferably in the range from 60% to 100% of the vacuum wavelength lambda and in particular in the range from 70% to 90% of the vacuum wavelength lambda were particularly advantageous.

Here, the nearest adjacent corner means the closest corner, i.e., the corner with the shortest distance from the center of the dipole antenna or from the center of the slot antenna of the RFID transponder.

The optimum distance range here depends on the vacuum wavelength lambda of the operating frequency f of the RFID transponder. If the operating frequency f of the RFID transponder is, for example, in the UHF range at, for example, 866.6 MHz, this corresponds to a vacuum wavelength lambda of 34.6 cm. A distance D in the range from 40% to 100% of the vacuum wavelength lambda then means a distance D from 13.8 cm (=40% of 34.6 cm) to 34.6 cm (=100% of 34.6 cm).

The invention is a result of extensive experimental investigations undertaken on glazings with the aforementioned basic structure.

The glazing unit according to the invention advantageously consists of or includes a single pane, a composite pane, or a fire-resistant glazing unit, in particular with at least one intumescent layer.

The glazing unit according to the invention consists of or contains at least one and preferably exactly one insulating glazing unit, which comprises:
at least one spacer, which is perimetrally formed into a spacer frame and delimits an inner region,
a first glass pane that is arranged on a pane contact surface of the spacer frame and a second glass pane that is arranged on a second pane contact surface of the spacer frame, and
the glass panes protrude beyond the spacer frame and form an outer region that is filled, at least in some sections, preferably completely, with a sealing element.

Advantageously, at least one RFID transponder is arranged on the frame in the inner region of the frame. Preferably, the RFID transponder is arranged on an interior-side surface of the frame, particularly preferably on an interior-side end face of the frame or an interior-side surface of the first or the second frame element, which is arranged parallel to the large surfaces of the glazing unit. In particular, the RFID transponder is arranged directly on the interior-side surface of the frame. Here, “directly” means that the RFID transponder is connected to the frame either directly or only by an adhesive layer, preferably an adhesive film or a double-sided adhesive tape.

Alternatively or in combination with this, at least one RFID transponder is arranged on the glazing unit, preferably on an external (primary) surface or on one of the end faces of the glazing unit. In the case of an insulating glazing unit, at least one RFID transponder can be arranged in the outer region of the insulating glazing unit, i.e., in the region between the glass panes protruding beyond the spacer frame, preferably in the sealing element.

With regard to the application situation, the inventors carried out, in particular, investigations on glazing units embedded in metallic frames, using the example of insulating glazing units, wherein the frame consists of two metal and thus electrically conductive frame elements that are connected via a polymeric and electrically insulating frame element. Such frames made of two metallic frame elements that are connected by a polymeric frame element are particularly advantageous since the polymeric frame element significantly reduces heat transfer from the first frame element to the second frame element and, thus, for example, from an exterior-space side to an interior-space side.

Elastomer profiles that seal the glazing and fix the glass panes are arranged between the outer sides of the glass panes and the inner sides of the adjacent metallic frame elements.

Commercially available UHF RFID transponders, whose structure and functionality are well known and, consequently, need not be further described here, were used in the investigations.

In one embodiment of the glazing according to the invention, the RFID transponder is implemented as a dipole antenna. Such designs can be arranged particularly well in the elongated and strip-shaped outer region along the spacer and between the glass panes, on the end faces of the glass panes, or on the outer surfaces of the glass panes within the frame.

The dipole antenna includes or consists of at least one first antenna pole and one second antenna pole. Preferably, the antenna poles are arranged one behind the other in a line and thus parallel to one another. RFID electronics or a connection to RFID electronics is usually arranged in the center, between the antenna poles.

The radio wavelengths used in such RFID transponder systems are usually, depending on type, in the range of UHF at 865-869 MHz (including European frequencies) or 902-928 MHz (USA and other frequency bands). The frequencies released for UHF RFID transponders differ regionally for Asia, Europe, and America and are coordinated by the ITU.

Radio signals with these frequencies penetrate both wood and conventional plastics, but not metals. In particular, when the dipole antenna is arranged directly on a metallic section of the frame, this can lead to a short-circuit of the dipole antenna and thus to undesirable impairment of the RFID transponder.

Consequently, in a preferred embodiment of the RFID transponder, the dipole antenna is arranged on a dielectric carrier element, particularly preferably a polymeric carrier element. The thickness of the carrier element is adapted to the material and, in particular, to the dielectric constant of the carrier element and to the geometry of the dipole.

It goes without saying that the dipole antennas together with electronics per se can be arranged on a dielectric carrier layer and, for example, a polymeric carrier layer, significantly simplifying assembly and prefabrication.

In an alternative glazing according to the invention, the RFID transponder is implemented as a slot antenna. Slot antennas also have an elongated design. However, the E-field typically runs perpendicular to the direction of extension of the slot antenna. In other words, in the case of the slot antenna, the E-field runs orthogonal to the E-field of a dipole antenna. The same applies to the H-fields.

If an RFID transponder according to the invention with a slot antenna is arranged in a glazing according to the invention in the usual and, for geometric reasons, only possible orientation (i.e., with the direction of extension parallel to the adjacent frame or spacer), the radiated E-field in the near field region is orthogonal to the direction of extension of the frame or spacer. In such a configuration, the E-field is only slightly absorbed or attenuated. Consequently, the E-field radiated by the slot antenna can much more easily emerge from the cavity (formed by the façade frame and spacer) and the RFID transponder according to the invention can be read from a greater distance.

In an advantageous embodiment of an RFID transponder according to the inventions with a slot antenna, RFID electronics are galvanically connected or electromagnetically coupled to a slot antenna. In the context of the present invention, “electromagnetically coupled” means that two components are coupled by an electromagnetic field, i.e., are connected both capacitively and inductively and preferably not galvanically. Consequently, here, “electromagnetically coupled” means that the slot antenna and the RFID transponder are coupled by an electromagnetic field, i.e., both capacitively and inductively and preferably not galvanically.

“Slot antennas” are known per se to the person skilled in the art, for example, from DE894573.

The slot antenna according to the invention contains at least one main body made of an electrically conductive material. The main body is preferably in the form of a plate or foil, particularly preferably with a rectangular base surface (length×width).

The main body has at least one, preferably exactly one, slot-shaped cutout, called “slot” in the following for short. The slot-shaped cutout is substantially rectangular. The slot forms an open passage along the thickness direction (i.e., the smallest dimension of the main body) from the upper side of the main body to its lower side. The slot is completely surrounded by the main body in the surface (i.e., in the other dimensions).

In an advantageous embodiment of the glazing according to the invention, the main body includes or consists of a self-supporting metal foil, preferably made of aluminum, an aluminum alloy, copper, silver, or stainless steel. Preferred metal foils have a thickness of 0.02 mm to 0.5 mm and in particular of 0.09 mm to 0.3 mm. Such main bodies for slot antennas can be easily integrated into the glazing and are, moreover, simple and economical to produce. It goes without saying that the metal foil can also be stabilized or electrically insulated on one or both sides by a polymer film. The slot is preferably a cutout only in the metal foil or in the metal foil and the polymer film.

In an alternative advantageous embodiment of the glazing according to the invention, the main body of the slot antenna includes or consists of a metalized polymer film with a preferred metallization of aluminum, an aluminum alloy, copper, silver, or stainless steel. Preferred metal foils have a thickness of 10 μm to 200 μm. The slot is advantageously a cutout only in the metallization. Such main bodies can also be easily integrated into the glazing and are, moreover, simple and economical to produce.

The preferred lengths and widths of the slot antenna, i.e., the length LG and the width BG of the main body and the length LS and the width BS of the slot as well as the position of the slot within the main body depends on the operating frequency of the RFID transponder and the respective conditions of the installation situation.

Advantageously, the length LG of the main body, i.e., the length parallel to the direction of extension of the slot antenna is from 25 mm to 200 mm, preferably from 40 mm to 170 mm, and in particular from 80 mm to 150 mm.

Advantageously, the width BG of the main body, i.e. the length transverse to the direction of extension of the slot antenna is from 10 mm to 80 mm, preferably from 12 mm to 40 mm, and in particular from 15 mm to 30 mm.

Advantageously, the length LS of the slot, i.e., the length parallel to the direction of extension of the slot antenna is from 20 mm to 180 mm, preferably from 35 mm to 160 mm, and in particular from 70 mm to 140 mm.

Advantageously, the width BS of the slot, i.e., the length transverse to the direction of extension of the slot antenna is from 0.2 mm to 20 mm, preferably from 1 mm to 10 mm, and in particular of 2 mm to 5 mm.

Such designs can be arranged particularly well on the elongated interior-side surfaces of the frame of the glazing. Particularly preferred is the arrangement of an RFID transponder with a slot antenna on the polymeric third frame element and, in particular, directly thereon. Here, “directly” means that the RFID transponder is connected to the polymeric third frame element either directly or only by an adhesive layer, preferably an adhesive film or a double-sided adhesive tape.

In an advantageous further development, the slot of the slot antenna is arranged directly on the polymeric third frame element and the main body of the slot antenna is galvanically or electromagnetically coupled on one or both sides to the metallic first frame element and/or the metallic second frame element. The coupling results in an advantageous improvement of the readout ranges of the RFID signal.

The person skilled in the art will carry out the further specific dimensioning in consideration of the dimensions of the insulating glazing unit on the one hand and the enclosing frame on the other, in particular taking into account the width of the frame.

The RFID electronics are preferably arranged centrally relative to the direction of extension of the slot or in one of the end regions of the slot or somewhere between. and galvanically connected and/or electromagnetically coupled to the main body.

The selection of the position of the RFID electronics can be used to optimize the impedance matching between the RFID electronics and the antenna.

The radio wavelengths used in such RFID transponder systems with slot antennas are usually, depending on type, in the range of UHF at 865-869 MHz (including European frequencies) or 902-928 MHz (USA and other frequency bands) or of SHF at 2.45 GHz and 5.8 GHz. The frequencies released for UHF RFID transponders differ regionally for Asia, Europe, and America and are coordinated by the ITU.

For RFID transponders with slot antennas in the UHF range, in particular for RFID transponders at 865-869 MHz (including European frequencies) or 902-928 MHz (USA and other frequency bands), it was possible to achieve particularly good results.

Radio signals with these frequencies penetrate both wood and conventional plastics, but not metals. In particular, when the entire slot antenna is arranged directly on a metallic spacer or on a metallic foil or on a metallized film on the spacer, this can lead to a short-circuit of the slot antenna and thus to undesirable impairment of the RFID transponder.

In a preferred embodiment, the slot antenna according to the invention can be coupled in sections to a metal body, such as a metallic spacer or a metallic foil or a metallized film on the spacer. For this purpose, a strip of the main body is preferably brought between the slot and the border of the main body in the immediate vicinity of or in contact with the metal body, with the strip of the main body opposite the slot and the slot itself arranged as far away from it as possible.

For example, a strip of the main body can, for example, be arranged on the metallic or metallized spacer, and the slot and the opposite strip of the main body can be arranged angled at an angle of approx. 90° on the inner surface of one of the glass panes.

Alternatively, in a preferred embodiment of the RFID transponder, the slot antenna can be arranged on a dielectric carrier element, particularly preferably on a polymeric carrier element. In this case, the thickness of the carrier element is adapted to the material and in particular to the dielectric constant of the carrier element and to the geometry of the slot antenna.

It goes without saying that the slot antennas together with RFID electronics per se can be arranged on a dielectric carrier layer and, for example, a polymeric carrier layer, significantly simplifying assembly and prefabrication.

The findings of the inventors apply in principle to both passive and active RFID transponders.

In light of the metal frame that surrounds the glazing unit and that, based on elementary laws of physics and according to the knowledge of the person skilled in the art based thereon, should sensitively interfere with, if not completely suppress, the high-frequency electromagnetic radiation of RFID transponders installed within the frame or their antennas, the proposed solution is surprising. It yields the unforeseen advantage that an RFID transponder placed according to the invention can still be read out at a relatively great distance of approx. 1.5 m from the glazing, in which the glazing according to the invention is installed.

It goes without saying that, by simple experiments, the person skilled in the art can find designs and positions with advantageous transmission and reception properties. The exemplary embodiments and aspects mentioned in the following are consequently primarily recommendations for the person skilled in the art, without restricting the implementation possibilities of the invention.

Thus, it goes without saying that a glazing can have a plurality of RFID transponders, in particular in the edge or outer regions of the various sides (top, bottom, right, left) of the glazing. This is usually necessary with prior art glazings with only short ranges of the RFID transponders in order to quickly find an RFID signal and quickly identify the glazing together with the glazing unit arranged therein. As a result of the increase according to the invention in the range of the RFID transponders, exactly one or few RFID transponders per glazing usually suffice.

There are various options for the placement of the RFID transponder in the glazing from which the person skilled in the art can select a suitable one, taking into account the specific mounting technology and also in light of the specific façade or window construction.

It goes without saying that multiple RFID transponders can also be arranged at positions different from those mentioned above.

In an advantageous embodiment of the glazing according to the invention, the glazing unit has a rectangular shape. Furthermore, it has at least four and preferably exactly four RFID transponders. In each case, an RFID transponder is arranged in the region of one of the four corners of the glazing unit. Each RFID transponder has a distance D according to the invention from the nearest corner of the glazing unit. In other words, the distance D between the center of the dipole antenna or the center of the slot antenna (i.e., the center of the slot in the direction of extension) and the nearest adjacent corner of the glazing unit is from 40% to 100% of the vacuum wavelength lambda, preferably from 60% to 100%, and in particular from 70% to 90%.

In another advantageous embodiment of the glazing according to the invention, the glazing unit has a rectangular shape. Furthermore, the glazing has exactly two RFID transponders. In each case, an RFID transponder is arranged in the region of two corners diagonally opposite relative to the glazing. Each RFID transponder has a distance D according to the invention from the nearest corner of the glazing unit. In other words, the distance D between the center of the dipole antenna or the center of the slot antenna (i.e., the center of the slot in the direction of extension) and the nearest adjacent corner of the glazing unit is from 40% to 100% of the vacuum wavelength lambda, preferably from 60% to 100%, and in particular from 70% to 90%.

In an advantageous further development, the glazing according to the invention has at least one strip-shaped coupling element, which is electromagnetically coupled to the RFID transponder, with the coupling element galvanically or capacitively coupled in at least one coupling region to one of the metallic frame elements and preferably in two coupling regions to one of the metallic frame elements in each case.

This further development of the invention includes the idea of arranging a coupling element that is provided separately from the RFID transponder on the insulating glazing unit such that with suitable installation in a glazing, it couples optimally with its frame and effects signal transfer from the frame to the antenna of the RFID transponder or from the antenna of the RFID transponder to the frame and thus to the outside of the glazing. The advantage according to the invention due to the defined distance D can thus be further improved.

The coupling element is electromagnetically coupled to an antenna pole of the dipole antenna or of the slot antenna of the RFID transponder.

Here, the term “electromagnetically coupled” means that the coupling element and the RFID transponder are coupled by an electromagnetic field, i.e., are connected both capacitively and inductively and preferably not galvanically.

In a glazing according to the invention, the RFID transponder is implemented as a dipole antenna. The coupling element according to the invention is arranged in some sections congruently above the RFID transponder. In this context, “in some sections congruently” means that the coupling element covers the dipole antenna in some sections in the orthogonal projection onto the RFID transponder.

If the RFID transponder is arranged, for example, on the inner side of the end face of the frame, the coupling element covers the RFID transponder and, in particular, one antenna pole of the dipole antenna of the RFID transponder, in some sections in the viewing direction perpendicular to the end face of the frame. It goes without saying that for optimal capacitive coupling of the coupling element to the RFID transponder and forwarding the RFID radio signal according to the invention, the coupling element is at least similar in size to the dipole antenna of the RFID transponder. In particular, the coupling element protrudes beyond the dipole antenna in the projection both on one side along the direction of extension of the dipole antenna and also transversely to the direction of extension. Here, the direction of extension of the dipole antenna is the longitudinal direction of the dipole antenna, i.e., along its antenna poles arranged linearly relative to one another and in the direction of its straight extension.

In an advantageous embodiment of the glazing according to the invention, the coupling element includes or consists of a self-supporting metal foil, preferably made of aluminum, an aluminum alloy, copper, silver, or stainless steel. Preferred metal foils have a thickness of 0.02 mm to 0.5 mm and in particular of 0.09 mm to 0.3 mm. Such coupling elements can be readily integrated into the glazing and are, moreover, simple and economical to produce. It goes without saying that the metal foil can also be stabilized by a polymer film or can be electrically insulated on one or both sides.

In an alternative advantageous embodiment of the glazing according to the invention, the coupling element includes or consists of a metallized polymer film with a preferred metallization of aluminum, an aluminum alloy, copper, silver, or stainless steel. Preferred metal layers have a thickness of 10 μm to 200 μm. Such coupling elements can also be readily integrated into the glazing and are, moreover, simple and economical to produce.

The coupling element according to the invention is advantageously arranged between the RFID transponder and at least one section of one of the frame elements.

In an advantageous embodiment, the coupling element is arranged directly on the frame elements and capacitively or galvanically connected to the metallic frame elements.

In an alternative advantageous embodiment, an electrical insulation layer that galvanically separates the coupling element from the metallic frame elements is arranged between the coupling element and the metallic frame elements in some sections. This is in particular advisable when the coupling element itself does not already have an electrically insulating carrier film or sheathing, in order to reduce the thermal coupling between the outer and inner sides. Such galvanic insulation prevents short-circuiting of the coupling element in undesirable areas, which can limit its functionality. The insulation layer is, for example, a polymer film or a paint film made of an electrically insulating material.

The coupling element according to the invention is advantageously arranged, at least in some sections, on the interior-side end face of the frame.

The coupling element protrudes, at least in the region of one of the metallic frame elements, beyond the interior-side end face transversely to the direction of extension. Here, the “direction of extension” of the frame means the direction of the long side of the frame as opposed to the short side of the frame, which is formed merely by the depth of the frame orthogonal to the surfaces of the glazing.

In an advantageous embodiment of a glazing according to the invention, the coupling element protrudes beyond the interior-side end face of the frame by a projection U. The coupling element is arranged in the region of the projection on the interior-side surface of the frame element that runs parallel to the large surfaces of the glazing. The maximum projection depends on the width of the metallic frame element and in particular on the thickness of the elastomer profile, which is, for example, 6 mm to 7 mm.

The projection U is preferably from 2 mm to 30 mm, particularly preferably from 5 mm to 15 mm, and in particular from 7 mm to 10 mm.

The preferred length L of the coupling element, i.e., the length parallel to the direction of extension of the dipole antenna, depends on the operating frequency f of the RFID transponder.

In another advantageous embodiment of a glazing according to the invention, the coupling element has a length L parallel to the dipole antenna greater than or equal to 40% of the half vacuum wavelength lambda/2 of the operating frequency f of the dipole antenna, preferably from 40% to 240%, particularly preferably from 60% to 120%, and in particular from 70% to 95%.

For RFID transponders in the UHF range, in particular for RFID transponders at 865-869 MHz (including European frequencies) or 902-928 MHz (USA and other frequency bands), it was possible to obtain particularly good results for coupling elements with a length L of more than 7 cm, preferably of more than 10 cm, and in particular of more than 14 cm. The maximum length was less critical. For example, maximum lengths of 30 cm still led to good results and good reading ranges.

In an alternative advantageous embodiment of a glazing according to the invention, the coupling element has a length L parallel to the dipole antenna from 7 cm to 40 cm, preferably from 10 cm to 20 cm, and in particular from 12 cm to 16 cm.

In an advantageous embodiment of a glazing according to the invention, the coupling element covers only one antenna pole of the dipole antenna and protrudes beyond the antenna pole on the side facing away from the other antenna pole. Here, “to cover” means that the coupling element is arranged in front of the respective antenna pole in the viewing direction toward the RFID transponder and covers it. Or, in other words, the coupling element covers the respective antenna pole in the orthogonal projection.

For example, the coupling element covers only the first antenna pole of the dipole antenna and extends beyond the first antenna pole on the side facing away from the second antenna pole. Alternatively, the coupling element covers only the second antenna pole of the dipole antenna and extends beyond the second antenna pole on the side facing away from the first antenna pole.

Advantageously, one edge of the coupling element is arranged above the center of the dipole antenna and extends over the first or the second antenna pole. As investigations by the inventors revealed, the coupling element can also have a small offset V between the edge of the coupling element and the center of the dipole antenna, wherein the offset V is measured in the projection of the coupling element onto the dipole antenna. The offset V thus means that the projection of the edge of the coupling element is not arranged exactly in the center between the antenna poles of the dipole antenna, but, instead, deviates by an offset V therefrom in the direction of extension of one antenna pole or in the direction of extension of the other antenna pole.

The respective maximum offset depends on the half vacuum wavelength lambda/2 of the operating frequency f of the dipole antenna.

An offset of V=0 is optimal. However, it was still possible to achieve good results and reading ranges for deviations from this. Advantageously, the offset V is from −20% to +20% of the half vacuum wavelength lambda/2 of the operating frequency f of the RFID transponder, preferably from −10% to +10%, and in particular from −5% to +5%.

In another advantageous embodiment of the invention, the offset V at an operating frequency f of the RFID transponder in the UHF range is from −30 mm to +30 mm, preferably from −20 mm to +20 mm, and in particular from −10 mm to +10 mm. Here, a positive sign means, for example, that the edge of the coupling element is arranged in the projection on the second antenna pole and the remainder of the second antenna pole is completely covered; whereas, in contrast, the first antenna pole is completely uncovered. Conversely, a negative sign means that the edge of the coupling element is arranged in the projection on the first antenna pole, and a section of the first antenna pole as well as the remainder of the second antenna pole is completely covered.

The width of the coupling element advantageously depends on the width of the frame and, optionally, on the respective projection beyond the interior-side end face of the frame on one side or both sides. Typical widths are from 2 cm to 10 cm and preferably from 3 cm to 5 cm.

The person skilled in the art will carry out the specific dimensioning under consideration of the dimensions of the glazing, on the one hand, and of the surrounding frame, on the other, in particular taking into account the width of the frame.

The coupling element according to the invention is galvanically or capacitively coupled in at least one coupling region with one of the metallic frame elements and preferably in two coupling regions with one of the metallic frame elements in each case. The coupling element is preferably in direct contact with the metallic frame element and is galvanically connected thereto, for example. Preferably, the coupling element contacts the metallic frame element over its entire length.

The coupling element does not have to be fixedly anchored to the metallic frame element. Instead, even loose contact or clamping is sufficient. In particular, capacitive coupling between the coupling element and the metallic frame element in the coupling region suffices.

In another advantageous glazing according to the invention, the RFID transponder is arranged on the polymeric third frame element, and
a first strip-shaped coupling element is arranged between the first antenna pole of the dipole antenna and the third frame element, which is capacitively or galvanically coupled to the first frame element, and
a second strip-shaped coupling element is arranged between the second antenna pole of the dipole antenna and the third frame element, which is capacitively or galvanically coupled to the second frame element.

For this purpose, the first coupling element extends only to a section of the first frame element and not to the second frame element. Furthermore, the second coupling element extends only to a section of the second frame element and not to the first frame element.

It goes without saying that a glazing according to the invention need not have a coupling element or functionally equivalent components. In other words, in an alternative advantageous embodiment of the invention, the glazing according to the invention has no electrically conductive active or passive components and, in particular, no coupling elements are arranged between an RFID transponder and the frame elements.

Advantages and functionalities of the invention are also evident from the following description of exemplary embodiments and aspects of the invention with reference to the figures. The drawings are purely schematic representations and not to scale. They in no way restrict the invention. They depict:

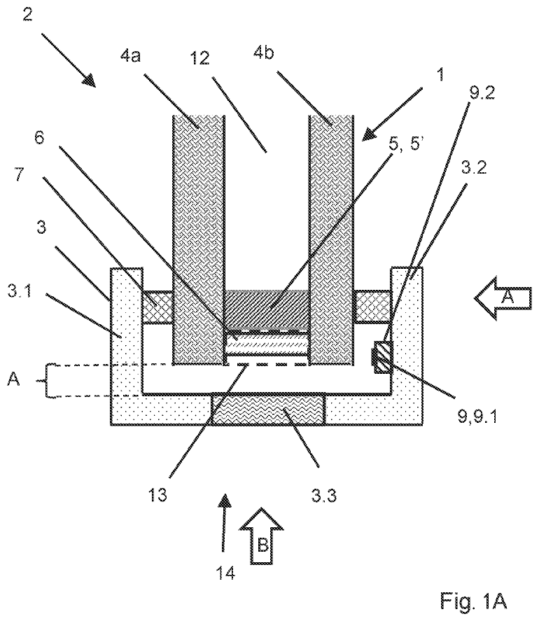

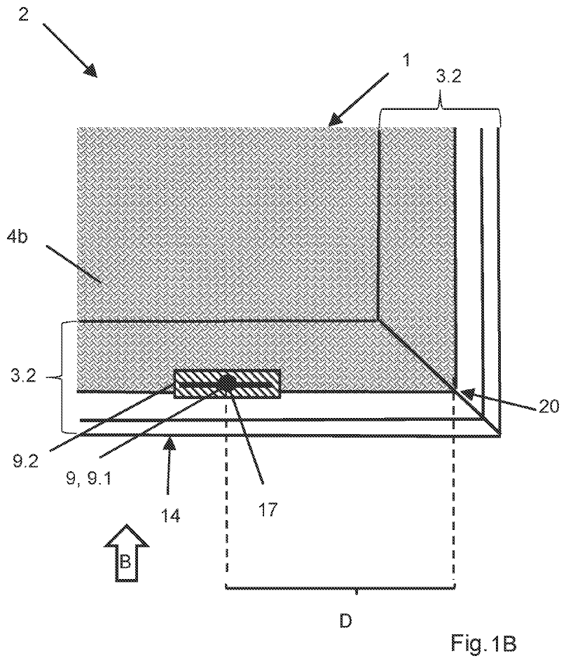

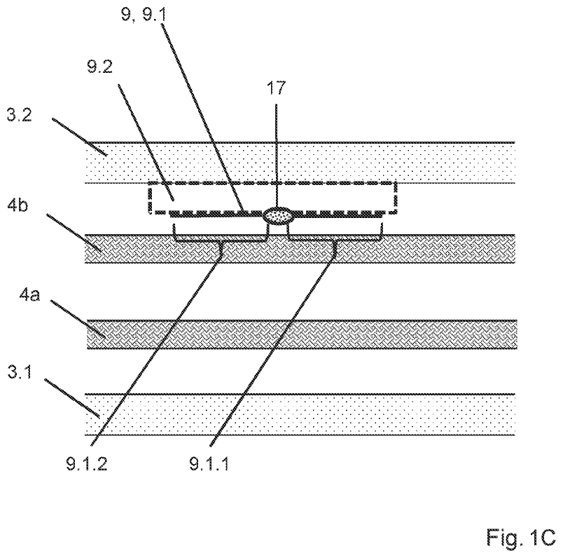

FIG. 1A a detailed view (cross-sectional representation) of an edge region of a glazing with an insulating glazing unit in accordance with an embodiment of the invention,

FIG. 1B a detailed view (plan view) of a detail of the glazing with an insulating glazing unit of FIG. 1A,

FIG. 1C a detailed view (cross-sectional representation) of the glazing in a sectional plane parallel to the end face of the insulating glazing unit of FIG. 1A,

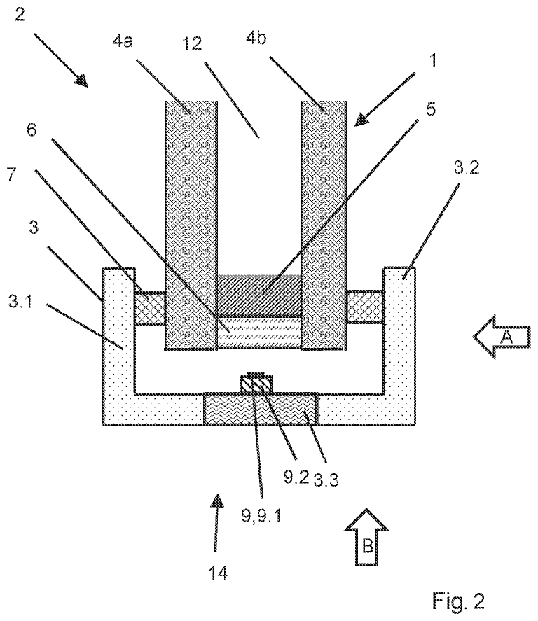

FIG. 2 a detailed view (cross-sectional representation) of an edge region of a glazing with an insulating glazing unit in accordance with another embodiment of the invention,

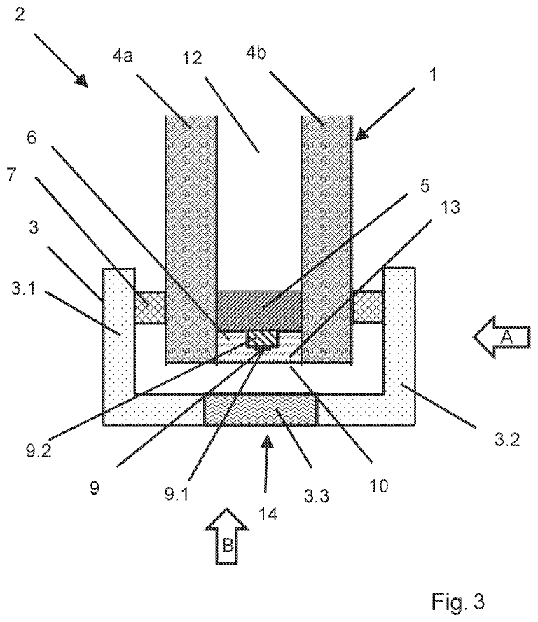

FIG. 3 a detailed view (cross-sectional representation) of an edge region of a glazing with an insulating glazing unit in accordance with another embodiment of the invention,

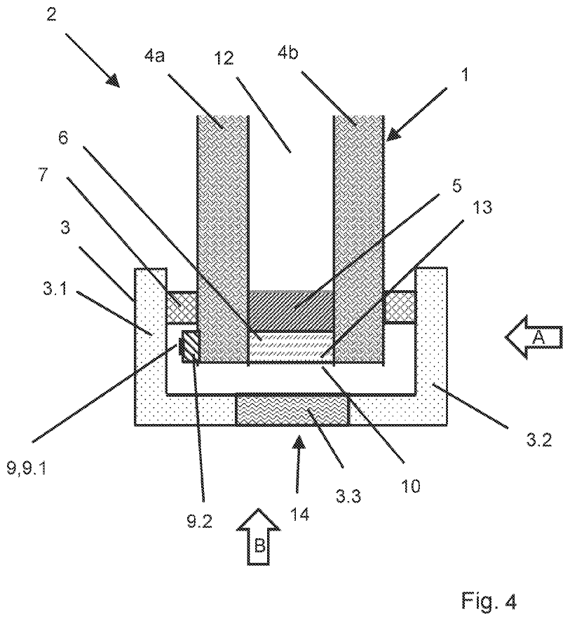

FIG. 4 a detailed view (cross-sectional representation) of an edge region of a glazing with an insulating glazing unit in accordance with another embodiment of the invention,

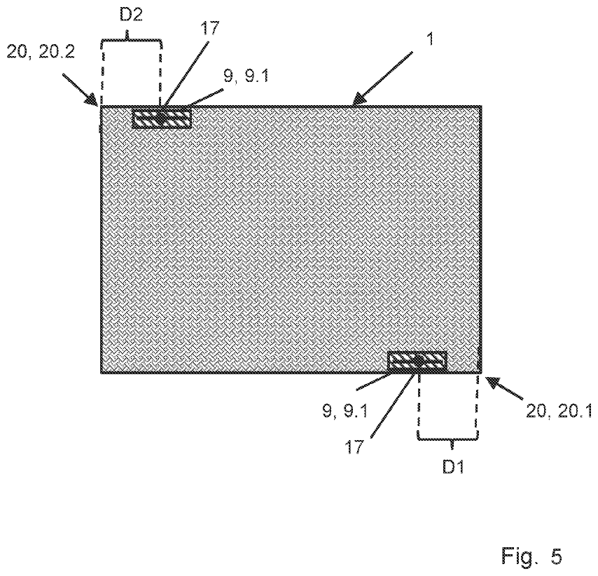

FIG. 5 a greatly simplified representation of a plan view of a glazing according to the invention.

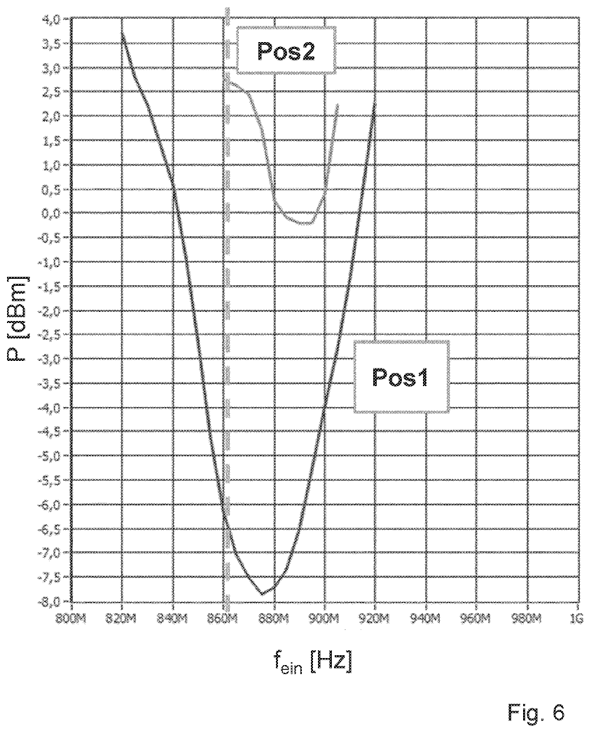

FIG. 6 measurement results of the turn-on power as a function of the irradiated frequency of a glazing according to the invention compared to a prior art glazing,

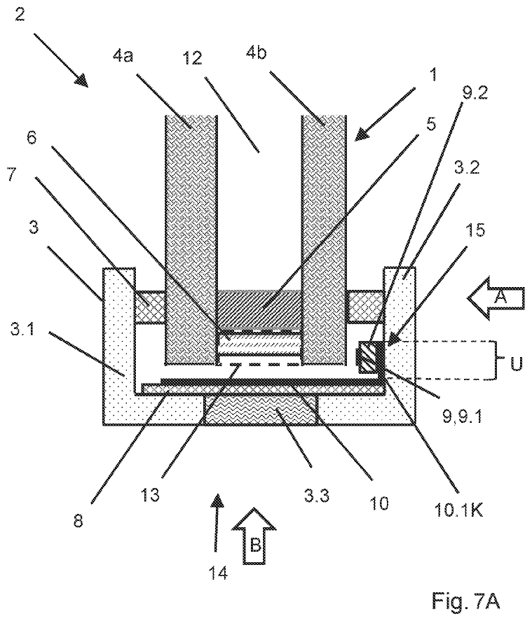

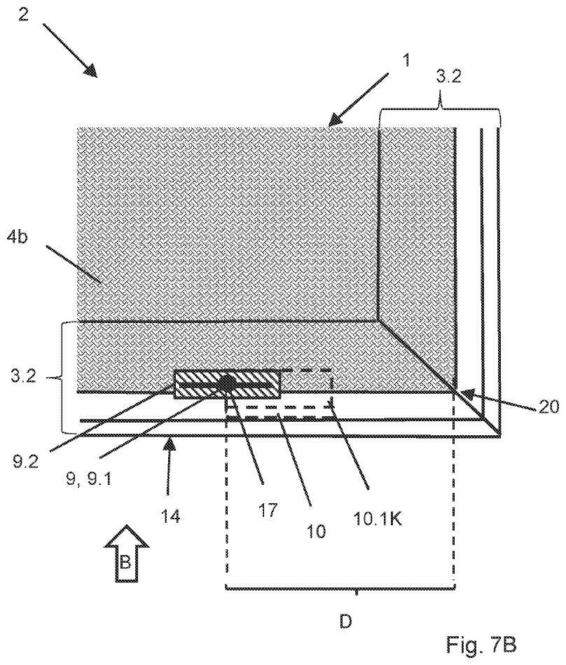

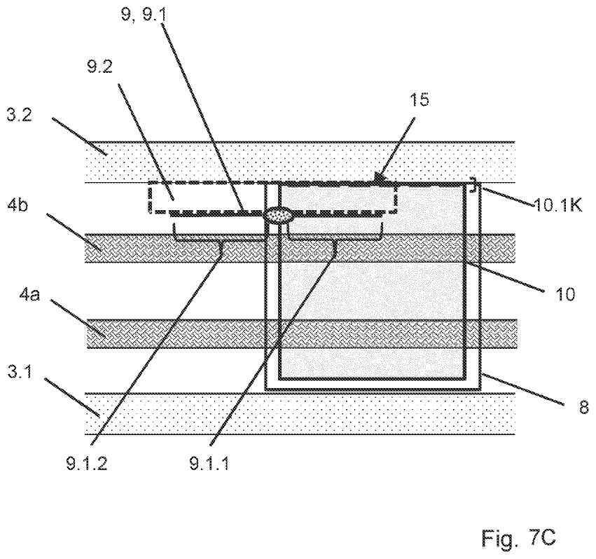

FIG. 7A a detailed view (cross-sectional representation) of an edge region of a glazing with an insulating glazing unit in accordance with another embodiment of the invention,

FIG. 7B a detailed view (plan view) of a detail of the glazing with an insulating glazing unit of FIG. 7A,

FIG. 7C a detailed view (cross-sectional representation) of the glazing in a sectional plane parallel to the end face of the insulating glazing unit of FIG. 7A,

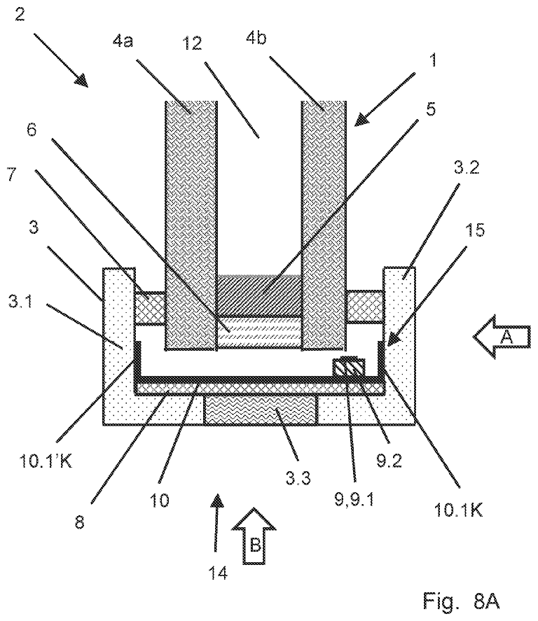

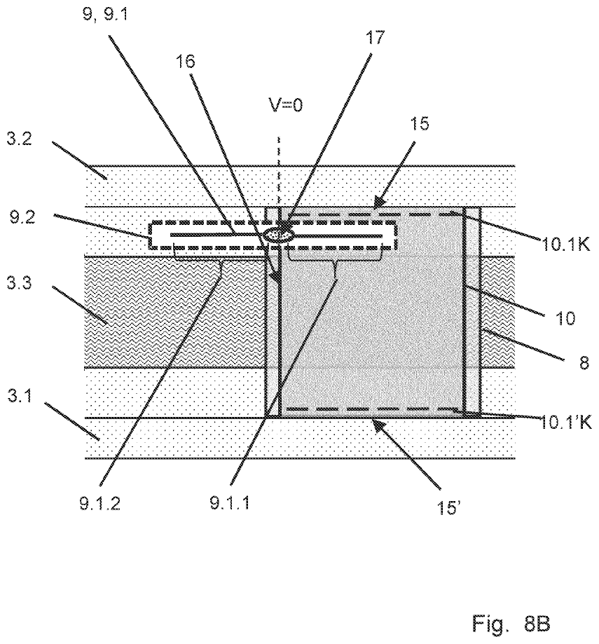

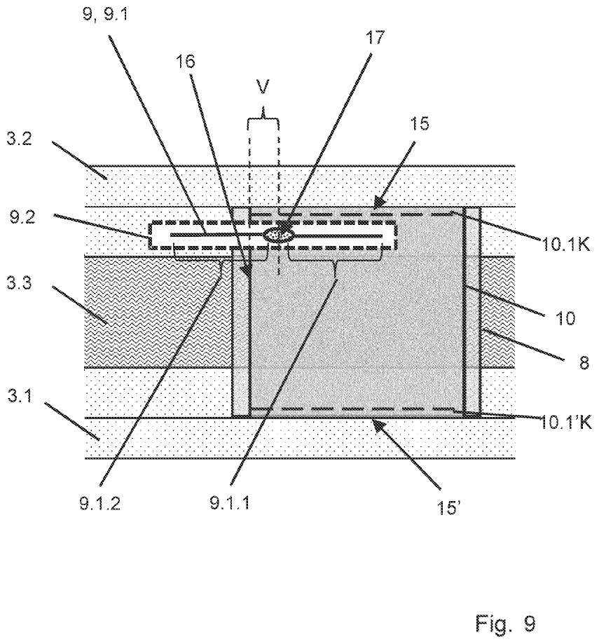

FIG. 8A a detailed view (cross-sectional representation) of an edge region of a glazing with an insulating glazing unit in accordance with another embodiment of the invention,

FIG. 8B a detailed view (cross-sectional representation) of a glazing in a sectional plane parallel to the end face of the insulating glazing unit in accordance with another embodiment,

FIG. 9 a detailed view (cross-sectional representation) of a glazing in a sectional plane parallel to the end face of the insulating glazing unit in accordance with another embodiment,

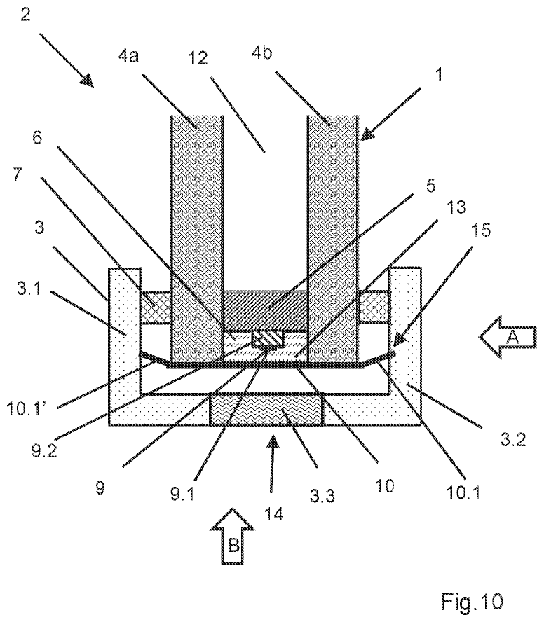

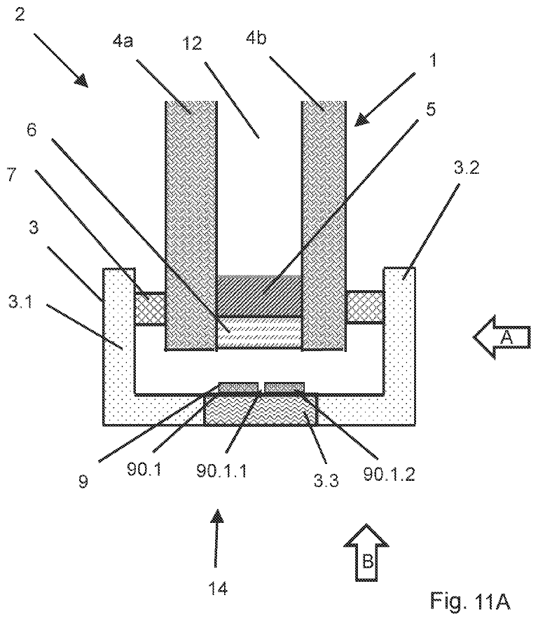

FIG. 10 a detailed view (cross-sectional representation) of an edge region of a glazing with an insulating glazing unit in accordance with another embodiment of the invention,

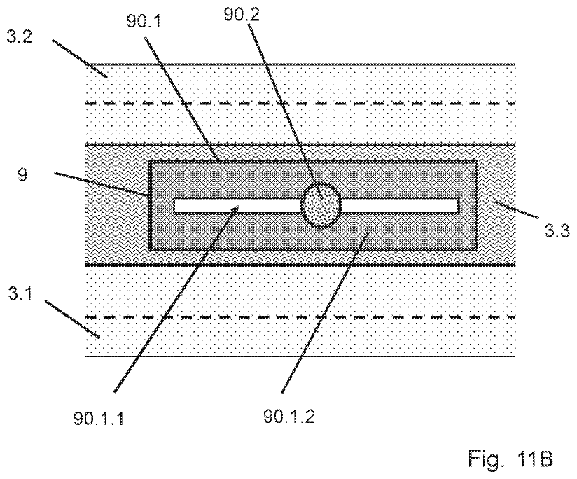

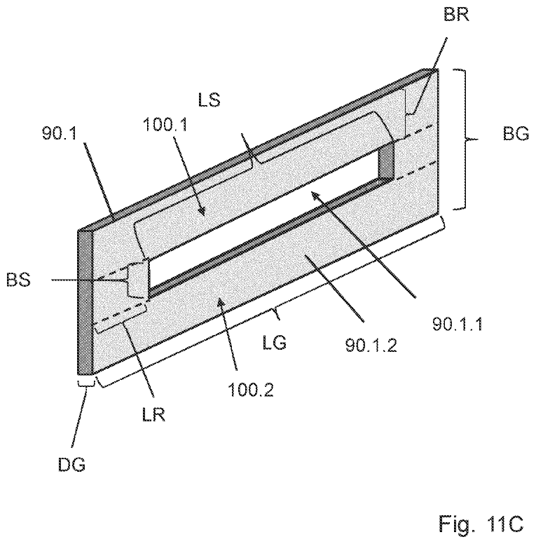

FIG. 11A a detailed view (cross-sectional representation) of an edge region of a glazing in accordance with another embodiment of the invention,

FIG. 11B a plan view of a detail of the edge region of a glazing in accordance with the embodiment of the invention of FIG. 11A, and

FIG. 11C a detailed view (perspective representation) of a slot antenna according to the invention.

In the figures as well as the following description, the glazing units as well as the glazings and the individual components are in each case identified with the same or similar reference numbers, regardless of the fact that the specific embodiments differ.

FIG. 1A depicts a detailed view (cross-sectional representation) of an edge region of a glazing 2 according to the invention with an insulating glazing unit 1.

It goes without saying that the glazing 2 can also have one or a plurality of glazing units comprising a single pane, a composite pane, or a fire-resistant glazing unit, in particular with an intumescent layer. All embodiments shown here apply in isolation and in combination to all types of glazing units.

FIG. 1B depicts a detailed view (plan view) of a detail of the glazing 2 with an insulating glazing unit 1 of FIG. 1A with a viewing direction in accordance with the arrow A of FIG. 1A.

FIG. 1C depicts a detailed view (cross-sectional representation) of the glazing 2 in a sectional plane parallel to the end face 14 of the insulating glazing unit 1 of FIG. 1A with a viewing direction along the arrow B of FIG. 1A.

The insulating glazing unit 1 comprises, in this embodiment, two glass panes 4a and 4b. These are held at a predetermined distance by a spacer 5 placed between the glass panes 4a, 4b near the end face 14 of the insulating glazing unit 1. The main body of the spacer 5 is made, for example, of glass-fiber-reinforced styrene acrylonitrile (SAN).

FIG. 1B depicts a schematic plan view of the insulating glazing unit 1 in a viewing direction indicated by the arrow A. FIG. 1B therefore depicts the second glass pane 4b lying on top.

Multiple spacers 5 (here, for example, four) are routed along the side edges of the glass panes 4a, 4b and form a spacer frame 5′. The pane contact surfaces of the spacers 5, i.e., the contact surfaces of the spacers 5 with the glass panes 4a, 4b, are bonded in each case to the glass panes 4a or 4b and thus mechanically fixed and sealed. The adhesive bond is made, for example, of polyisobutylene or butyl rubber. The inner surface of the spacer frame 5′ delimits, together with the glass panes 4a, 4b, an inner region 12.

The spacer 5 is usually hollow (not shown) and filled with a desiccant (not shown), which binds, via small interior-side openings (likewise not shown), any moisture that has penetrated into the inner region 12. The desiccant contains, for example, molecular sieves such as natural and/or synthetic zeolites. The inner region 12 between the glass panes 4a and 4b is filled, for example, with a noble gas, such as argon.

The glass panes 4a, 4b usually protrude beyond the spacer frame 5′ on all sides such that the outer surface of the spacer 5 and the outer sections of the glass panes 4a, 4b form an outer region 13. A sealing element (sealing profile) 6 is introduced into this outer region 13 of the insulating glazing unit 1 between the glass panes 4a and 4b and outside the spacer 5. This is shown here in simplified form as a single piece. In practice, it usually comprises two components, one of which seals the contact surface between the spacer 5 and the glass panes 4a, 4b and protects against penetrating moisture and external influences. The second component of the sealing element 6 additionally seals and mechanically stabilizes the insulating glazing unit 1. The sealing element 6 is, for example, formed from an organic polysulfide.

An insulation film (not shown here), which reduces the heat transfer through the polymeric spacer 5 into the inner region 12, is applied, for example, on the outer surface of the spacer 5, i.e., on the side of the spacer 5 facing the outer region 13. The insulation film can, for example, be attached to the polymeric spacer 5 with a polyurethane hot-melt adhesive. The insulation film includes, for example, three polymeric layers of polyethylene terephthalate with a thickness of 12 μm and three metallic layers made of aluminum with a thickness of 50 nm. The metallic layers and the polymeric layers are attached alternatingly in each case, with the two outer plies formed by polymeric layers. In other words, the layer sequence consists of a polymeric layer, followed by a metallic layer, followed by an adhesive layer, followed by a polymeric layer, followed by a metallic layer, followed by an adhesive layer, followed by a metallic layer, followed by a polymeric layer.

As already mentioned, the main body of the spacer 5 is made, for example, of glass-fiber-reinforced styrene acrylonitrile (SAN). By means of the selection of the glass fiber content in the spacer main body, its coefficient of thermal expansion can be varied and adjusted. By adjusting the coefficient of thermal expansion of the spacer main body and of the insulation film, temperature-induced stresses between the different materials and flaking of the insulation film can be avoided. The spacer main body has, for example, a glass fiber content of 35%. The glass fiber content in the spacer main body simultaneously improves strength and stability.

The first glass pane 4a and the second glass pane 4b are made, for example, of soda lime glass with a thickness of 3 mm and have, for example, dimensions of 1000 mm×1200 mm. It goes without saying that each insulating glazing unit 1 depicted in this and the following exemplary embodiments can also have three or more glass panes.

The glazing 2 further comprises a frame 3 that is, for example, U-shaped. In this example, the frame 3 comprises a first metallic frame element 3.1 that is connected to a second metallic frame element 3.2 via a polymeric, electrically insulating third frame element 3.3. In this example, the first and second frame elements 3.1, 3.2 are L-shaped. Consequently, the frame 3 surrounds the end face 14 of the insulating glazing unit 1 in the shape of a U. The sections of the first and second frame elements extending parallel to the large surfaces of the glass panes 4a, 4b are implemented such that they completely cover at least the outer region 13 with the sealing element 6 and the spacer frames 5′ in the viewing direction (arrow A) through the insulating glazing unit 1.

The frame 3 surrounds all end faces 14 of the insulating glazing 1 and forms a closed border. The distance A between the end face 14 of the insulating glazing unit 1 and the interior-side end face of the frame 3 is, for example, approx. 4 mm. The insulating glazing unit 1 is arranged on carriers (not shown here), in particular on plastic carriers or carrier elements electrically insulated by plastics. Furthermore, an elastomer profile 7 is arranged in each case between the metallic frame elements 3.1, 3.2 and the glass panes 4a, 4b such that the insulating glazing unit 1 is firmly held within the frame 3. The elastomer profile 7 has, for example, a thickness of 6.5 mm and fixes the distance between the respective frame elements 3.1, 3.2 and the glass panes 4a, 4b.

The glazing of FIG. 1A to 1C is, by way of example, provided with an RFID transponder 9 that is arranged on the second frame element 3.2. The RFID transponder 9 is arranged within the frame 3 and there on the inner surface of the second frame element 3.2, which runs parallel to the large surfaces of the glass panes 4a and 4b. It goes without saying that the RFID transponder 9 can also be arranged at other positions within the frame 3, for example, at one of the inner end faces of the frame elements 3.1, 3.2, 3.3 or at the inner surface of the first frame element 3.1, which extends parallel to the large surfaces of the glass panes 4a and 4b. In this case, the arrangement of the RFID transponder 9 on one of the metallic frame elements 3.1, 3.2 is preferable due to better signal coupling and decoupling.

The operating frequency f of the RFID transponder is in the UHF range and is, for example, around 866.6 MHz, which corresponds to a vacuum wavelength lambda of 34.6 cm.

Distances D according to the invention between the center 17 of the dipole antenna 9.1 and the nearest adjacent corner 20 of the glazing unit are in the range from 40% to 100% of the vacuum wavelength lambda, i.e., for a vacuum wavelength lambda of 34.6 cm in the range from 13.8 cm (=40% of 34.6 cm) to 34.6 cm (=100% of 34.6 cm). For example, the distance D is 80% of the vacuum wavelength lambda and thus 27.7 cm (=80% of 34.6 cm).

The example shown is an RFID transponder 9, in which the dipole antenna 9.1 is arranged on a dielectric carrier body 9.2. This is necessary because the second frame element 3.2 is electrically conductive. Without a dielectric carrier body 9.2, the dipole antenna 9.1 would be arranged directly on an electrically conductive surface and thus “short circuited”. By using an RFID transponder 9 with a dielectric carrier body 9.2 (a so-called “on-metal” RFID transponder), the short-circuit can be avoided.

FIG. 2 depicts a detailed view (cross-sectional representation) of an edge region of a glazing 2 with an insulating glazing unit 1 in accordance with another embodiment of the invention.

FIG. 2 depicts a modified design that largely has the elements and the structure of the glazing 2 with an insulating glazing unit 1 of FIG. 1A-C. Thus, the same reference numbers are used as there and the structure is not described again here.

The insulating glazing unit 1 of FIG. 2 differs from FIGS. 1A and 1C in that, here, the RFID transponder 9 is arranged directly on the inner end face of the third frame element 3.3. It goes without saying that it can also be arranged on the inner end face of the first frame element 3.1 or of the second frame element 3.2.

FIG. 3 depicts a detailed view (cross-sectional representation) of an edge region of a glazing 2 with an insulating glazing unit 1 in accordance with another embodiment of the invention.

FIG. 3 depicts a modified design that largely has the elements and the structure of the glazing 2 with an insulating glazing unit 1 of FIG. 1A-C. Thus, the same reference numbers are used as there and the structure is not described again here.

In the embodiment shown here, the RFID transponder 9 is arranged in the sealing element 6 within the outer region 13 of the insulating glazing unit 1 and directly on the outer side of the spacer frame 5.

FIG. 4 depicts another modified design that likewise largely has the elements and structure of the glazing 2 with an insulating glazing unit 1 of FIG. 1A-C. Thus, the same reference numbers are used as there and the structure is not described again here.

In the embodiment shown here, the RFID transponder 9 is arranged directly on the outer surface of the glass pane 4A [sic].

FIG. 5 depicts a greatly simplified schematic plan view of a glazing according to the invention, wherein only the glazing unit using the example of an insulating glazing unit 1 and two RFID transponders 9 are shown, and the frame 3 has been blanked out. The glazing has a first corner 20.1 and a second corner 20.2, which are situated diagonally opposite one another relative to the glass panes 4a,4b of the insulating glazing unit 1.

The insulating glazing 1 is, for example, rectangular in shape, with the horizontal, i.e., the top and bottom, sides longer than the vertical sides. The RFID transponders 9 are arranged, for example, corresponding to FIG. 4, directly on the insulating glazing 1.

One of the RFID transponders 9 is arranged at the lower edge of the insulating glazing 1, with the distance D1 between the center 17 of the dipole antenna 9.1 of the RFID transponder 9 arranged at the lower edge and the first corner 20.1 being 30 cm in this example.

A second RFID transponder 9 is arranged at the upper edge of the insulating glazing 1, with the distance D2 between the center 17 of the dipole antenna 9.1 arranged at the upper edge and the second corner 20.2 likewise being 30 cm in this example. It goes without saying that the distances D1 and D2 of the RFID transponders 9 within the region according to the invention can be selected independently of each other and need not be identical.

Modern insulating glazings 1 often have coatings that reduce the transmittance of thermal radiation, particularly in one direction. Such insulating glazings 1 have a front and a back side that must be arranged in a particular installation position relative to the radiation source (for example, the sun). The arrangement of two RFID transponders 9 at diagonally opposite corners 20.1,20.2 shown in FIG. 5 has the particular advantage that the correct installation relative to the front and back side of the insulating glazing 1 can be verified simply by checking whether the RFID transponders 9 are situated in the region of the specified corners 20.1, 20.2. The correct installation is independent of a rotation by 180° about an axis perpendicular to the large surfaces of the insulating glazing unit, i.e., of interchanging the upper and lower edge. Thus, for example, with correct installation of the RFID transponders 9 in the respective lower right corner 20.1 and the upper left corner 20.2 and with an insulation in which the front and back side of the glazing are reversed, the RFID transponders 9 are in the respective lower left corner and the upper right corner.

FIG. 6 depicts measurement results on a glazing 2 according to the invention and a prior art glazing with a passive UHF RFID transponder 9 in each case. The glazing has, for example, an area of 1.8 m×0.5 m. The RFID transponders 9 were arranged on the longer side in each case.

In the glazing 2 according to the invention, the RFID transponder 9 is arranged in a first position Pos1. Here, the distance D according to the invention from the center 17 of the dipole antenna 9.1 to the nearest corner 20 is 30 cm.

In the prior art comparative example, an RFID transponder 9 in a second position Pos2 in the center of the pane has a distance of 90 cm from the two nearest corners.

The turn-on power P, i.e., the necessary power irradiated in from the outside that is required for the operation of the passive RFID transponder 9, minus the typical distance-dependent attenuation of the signal in a vacuum, was measured. The turn-on power P was measured as a function of the irradiated frequency fₑᵢₙ. The vertical dashed line depicts the frequency range permitted in the European Union for UHF RFID applications from 865 Hz to 869 MHz.

The measurement results are to be interpreted to mean that the lower the required turn-on power, the greater the range for reading the RFID transponder with a commercially available and practical RFID reader.

The required power radiated in is, in the case of an RFID transponder that is situated at the position Pos1 according to the invention, as much as 9 times less than in the case of an RFID transponder at position Pos2 according to the prior art.

For example, the turn-on power at a frequency of of 866 MHz with an RFID transponder at position Pos1 is: −6 dBm (≈0.25 mW) and at position Pos2: 2.7 dBm (z 1.86 mW).

The measurement clearly shows that positioning the RFID transponder 9 at a distance D according to the invention is advantageous compared to positioning according to the prior art.

FIG. 7A depicts a detailed view (cross-sectional representation) of an edge region of another glazing 2 according to the invention with an insulating glazing unit 1.

FIG. 7B depicts a detailed view (plan view) of a detail of the glazing 2 with an insulating glazing unit 1 of FIG. 7A with a viewing direction according to the arrow A of FIG. 7A.

FIG. 7C depicts a detailed view (cross-sectional representation) of the glazing 2 in a sectional plane parallel to the end face 14 of the insulating glazing unit 1 of FIG. 7A with a viewing direction along the arrow B of FIG. 7A.

FIGS. 7A, 7B, and 7C correspond substantially in their structure to FIGS. 1A, 1B, and 1C, such that only the differences will be discussed in the following. In particular. the reference characters correspond.

In the exemplary embodiment according to FIGS. 7A, 7B, and 7C, a coupling element 10, made, for example, of a 0.1-mm-thick electrically conductive foil, for example, of an aluminum foil, is arranged on the inner end face 14 of the frame. Here, the coupling element 10 extends, for example, from the inner end face 14 of the first frame element 3.1 over the inner end face 14 of the third frame element 3.3, and over the inner end face 14 of the second frame element 3.2.

Here, the coupling element 10 can be arranged directly on the frame elements 3.1,3.2,3.3 (not shown in the figures here). This configuration is particularly simple and economical to produce.

Alternatively, an insulation layer 8 made, for example, of a polymeric film is arranged between the coupling element 10 and the respective sections of the frame elements 3.1,3.2,3.3. The polymeric film consists, for example, of a 0.16-mm-thick polyimide film. It goes without saying that the insulation layer 8 can also be part of an electrically insulating coating on one or both sides of the coupling element 10.

Moreover, the coupling element 10 is guided around the inner corner of the second frame element 3.2 on the inside relative to the frame 3 and formed in a region 10.1 of the coupling element 10 along the inner surface of the second frame element 3.2, which runs parallel to the large surfaces of the glass panes 4a and 4b. The coupling element 10 is arranged in this region 10.1K between the RFID transponder 9 and the second frame element 3.2. Moreover, the coupling element 10 is electromagnetically coupled to the RFID transponder 10 in this region 10.1K.

Additionally, the coupling element 10 is, for example, galvanically coupled to the second frame element 3.2 in this region 10.1K. It goes without saying that, in this region 10.1K, the coupling element 10 can also be coupled only electromagnetically to the second frame element 3.2, for example, via an insulation film and, in particular, via a continuation of the insulation film 8. The width of the region 10.1K is, for example, 9 mm.

One edge of the coupling element 10 is arranged roughly congruently over one of the two antenna poles of the dipole antenna 9.1. In other words, the edge of the coupling element 10 is arranged essentially in the center of the dipole antenna 9.1.

Here, “congruently arranged” means that the coupling element 10 is arranged within the orthogonal projection of the antenna pole of the dipole antenna 9.1 on the coupling element 10 and at least completely covers it. In other words, the coupling element 10 is arranged, with respect to a plan view, on the RFID transponder 9 and completely covers one antenna pole of the dipole antenna 9.1.

The length L of the coupling element 10 in its direction of extension parallel to the direction of extension of the dipole antenna 9.1 and thus parallel to the direction of extension of the long side of the frame 3, is, for example, 15 cm. Thus, the coupling element 10 is roughly as long as the dipole antenna 9.1 and thus protrudes beyond its end by approx. 50% on one side.

The example shown is an RFID transponder 9 in which the dipole antenna 9.1 is arranged on a dielectric carrier body 9.2. This is necessary, since both the coupling element 10 and the second frame element 3.2 are electrically conductive. Without the dielectric carrier body 9.2, the dipole antenna 9.1 would be arranged directly on an electrically conductive surface and thus “short-circuited”. Through the use of an RFID transponder 9 with a dielectric carrier body 9.2 (a so-called “on-metal” RFID transponder), the short-circuit can be avoided.

In the example here, half of the RFID transponder 9 is glued or clamped on the coupling element 10 above the metallic frame elements 3.2, and the other half is glued or clamped to the frame element 3.2 itself.

As shown in FIG. 7C, the dipole antenna 9.1 consists of a first antenna pole 9.1.1 and a second antenna pole 9.1.2, both of which are connected, in the center of the RFID transponder 9, to electronics. The coupling element 10 is arranged such that it completely covers the first antenna pole 9.1.1 and protrudes beyond the first antenna pole 9.1.1 on the side facing away from the second antenna pole 9.1.2.

Electromagnetic coupling occurs as a result of this covering and the small distance between the first antenna pole 9.1.1 and the coupling element 10.

As shown in detail in FIGS. 7A and 7C, the coupling element 10 is coupled to the metallic second frame 3.2 in a coupling region 15. For this purpose, the conductive foil of the coupling element 10 rests, for example, over its entire length, against the second frame element 3.2 and is galvanically connected thereto. It goes without saying that a capacitive coupling also suffices for coupling high-frequency signals in the operating range of the RFID transponder 9.

As investigations by the inventors surprisingly revealed, by coupling the coupling element 10 to the frame 3 of the glazing 2, the signal of the dipole antenna 9.1 of the RFID transponder 9 can be conducted to the outside in an improved manner; and, conversely, a signal can be supplied to the RFID transponder 9 from the outside in an improved manner. Surprisingly, the range of the RFID signal is again increased significantly compared to glazings 2 according to the invention with insulating glazing units 1 without a coupling element 10.

FIG. 8A depicts a detailed view (cross-sectional representation) of an edge region of a glazing 2 with an insulating glazing unit 1 in accordance with another embodiment of the invention.

FIG. 8B depicts a detailed view (cross-sectional representation) of the glazing in a sectional plane parallel to the end face 14 of the glazing 2 of FIG. 8A in the viewing direction of the arrow B of FIG. 8A.

FIGS. 8A and 8B depict a modified design that has largely the elements and the structure of the glazing 2 with an insulating glazing unit 1 of FIG. 7A-C. Thus, the same reference numbers are used as there and the structure is not described again here. The viewing direction in FIG. 8B points from the side of the insulating glazing unit 1 into the frame 3, i.e., counter to the direction of the arrow B of FIG. 8A.

The insulating glazing unit 1 of FIGS. 8A and 8B differs from FIGS. 7A and 7C in the design of the coupling element 10, which, here, protrudes beyond the inner end face of the frame 3 by a region 10.1K, 10.1′K on both sides. This results in two coupling regions 15, 15′, in which the coupling element 10 couples to the first and second frame elements 3.1, 3.2. Overall, this leads to symmetrization of the above-described properties for improving the readout ranges of the RFID signal such that the same signal strengths can be achieved on both sides of the glazing 2.

Furthermore, here, the RFID transponder 9 is arranged, for example, relative to the frame 3 and with the interposition of the coupling element 10 and the insulation layer 8, on the inner end face of the second frame element 3.2. It goes without saying that it can also be arranged on the inner end face of the first frame element 3.1 or the frame element 3.3.

FIG. 9 depicts a detailed view (cross-sectional representation) of a glazing 2 in a sectional plane parallel to the end face 14 according to another embodiment of the invention. Here, the viewing direction is from the side of the insulating glazing unit 1 into the frame 3, i.e., counter to the direction of the arrow B of FIG. 8A.

Here, one edge 16 of the coupling element 10 is not arranged centrally relative to the dipole antenna 9.1 (center of the dipole 17), but is shifted by an offset V of roughly 10 mm. The coupling element 10 thus also covers part of the second antenna pole 9.1.2. Nevertheless, it was possible to measure good RFID signals here. Overall, up to an offset V of 20% of the half vacuum wavelength lambda/2 of the operating frequency f of the RFID transponder 9, good and practically utilizable signals or sufficiently large maximum reading ranges can be obtained. It is irrelevant whether the offset V is in the direction of the first antenna pole 9.1.1 or in the direction of the second antenna pole 9.1.2. Investigations by the inventors revealed that such an arrangement also positively affects the reception/transmission characteristics and increases the achievable readout distance of the RFID transponder 9.

FIG. 10 depicts a detailed view (cross-sectional representation) of an edge region of a glazing 2 with an insulating glazing unit 1 in accordance with another embodiment of the invention.

FIG. 10 depicts a modified design that largely has the elements and the structure of the glazing 2 with an insulating glazing unit 1 of FIG. 7A-C. Thus, the same reference numbers are used as there and the structure is not described again here.

In the embodiment shown here, the RFID transponder 9 is arranged in the sealing element 6 within the outer region 13 of the insulating glazing unit 1 and directly on the spacer frame 5. The coupling element 10, which has here, for example, on both sides, a projection 10.1, 10.1′ beyond the second glass pane 4b and the first glass pane 4a, is arranged on the end faces 14 of the glass panes 4a and 4b. This yields two coupling regions 15, 15′, in which the coupling element 10 couples to the first and second frame elements 3.1, 3.2. Overall, this leads to a symmetrization of the above-described properties for improving readout ranges of the RFID signal such that equal signal strengths can be achieved on both sides of the insulating glazing unit 1.

FIG. 11A depicts a detailed view (cross-sectional representation) of an edge region of a glazing 2 with an alternative RFID transponder 9 with a slot antenna 90.1. The insulating glazing unit 1 and the glazing 2 of FIG. 11A correspond substantially to the insulating glazing unit 1 and the glazing 2 of FIG. 1A such that only the differences will be discussed in the following.

In contrast to the glazing 2 of FIG. 1A, the RFID transponder 9 is implemented as a slot antenna 90.1. Details of the slot antenna 90.1 can be found in FIGS. 11B and 11C and in the associated description of the figures. Furthermore, the slot antenna 90.1 is arranged on the polymeric third frame element 3.3.

FIG. 11B depicts a schematic plan view through the edge region of the glazing 2 of FIG. 11A in a viewing direction indicated by the arrow B of FIG. 11A.

The operating frequency of the RFID transponder is in the UHF range and is, for example, 866.6 MHz.

The example shows an RFID transponder 9 according to the invention with a slot antenna 90.1 in which the RFID electronics 90.2 are arranged in the center of the slot 90.1.1, the main body 90.1.2 of the slot antenna 90.1 is attached to the adjacent regions and is electrically conductively connected thereto, for example, by two galvanic connections on both sides of the slot 90.1.1 (in FIG. 11B: once at the top and once at the bottom. It goes without saying that the RFID electronics 90.2 can also be arranged at a different location and can be connected to the slot antenna 90.1 via lines, galvanic connections, or electromagnetic coupling.

FIG. 11C depicts a perspective representation of the slot antenna 90.1 according to the invention. This consists of a metallic main body 90.1.2, for example, made of a rectangular copper foil with a length LG of 140 mm, a width BG of 10 mm, and a thickness DG of 0.1 mm. The main body 90.1.2 has, for example, in the center a slot 90.1.1 in the form of a complete cutout with a length LS of 120 mm and a width BS of 2 mm. The edge region of the main body 90.1.2 around the slot 90.1.1 is consequently approx. 10 mm in the longitudinal direction (LR) in each case and approx. 4 mm in the transverse direction (BR) in each case. It goes without saying that lengths, widths, position of the slot, material, etc. can be adapted to the respective conditions of the installation situation, the radiation characteristics, and the RFID frequency.

Two strip-shaped regions (also called strips 100.1, 100.2) are situated between the slot 90.1.1 and the edge of the main body 90.1.2 along the direction of extension. In the example of FIG. 11C, these strips 100.1,100.2 are the same width and the same length.

The main body 90.1.2 can also be made of a comparatively rigid, thin metal plate or of a very thin metal foil or metallization that can be arranged on a carrier element, preferably a dielectric carrier element, such as a polymer plate or polymer film.

The slot antenna 90.1 is, for example, arranged directly on the polymeric third frame element 3.3. Since the material of the polymeric third frame element 3.3 is electrically insulating, the slot antenna 90.1 can, for example, be arranged directly on the polymeric third frame element 3.3, for example, bonded via a thin adhesive film or a double-sided adhesive tape.

The implementation of the invention is not limited to the above-described examples and highlighted aspects of the embodiments, but is also possible in a large number of modifications that are evident to the person skilled in the art from the dependent claims.

Another aspect of the invention relates to an RFID transponder 9 according to the invention, preferably at least one further RFID transponder 9 according to the invention 9, which is arranged
on the glazing unit, preferably on an external surface or on one of the end faces 14 of the insulating glazing unit, or
in the outer region 13 of the insulating glazing unit 1.

Another aspect of the invention relates to a glazing 2 according to the invention, wherein a strip-shaped coupling element 10 is electromagnetically coupled to the RFID transponder 9 and the coupling element 10 is galvanically or capacitively coupled in at least one coupling region 15 to one of the metallic frame elements 3.1,3.2 and preferably in two coupling regions 15,15′ to one of the metallic frame elements 3.1,3.2 in each case. This is particularly advantageous for RFID transponders 9 with dipole antennas 9.1.

In a preferred embodiment, the coupling element 10 according to the invention includes or consists of a metalized polymer film or a self-supporting metal foil, preferably made of aluminum, an aluminum alloy, copper, silver, or stainless steel.

In another preferred embodiment, the strip-shaped coupling element 10 according to the invention is arranged between the RFID transponder 9 and at least one section of one of the frame elements 3.1,3.2, 3.3.

In another preferred embodiment, the strip-shaped coupling element 10 according to the invention is arranged in sections congruently above the RFID transponder 9.

In another preferred embodiment of a glazing according to the invention, no electrically conductive components and, in particular, no coupling elements 10 are arranged between RFID transponder 9 and the frame elements 3.1,3.2, 3.3.

### LIST OF REFERENCE CHARACTERS

1 insulating glazing unit
2 glazing, insulating glazing
3 frame
3.1, 3.2 metallic first or second frame element
3.3 polymeric third frame element
4a, 4b glass panes
5 spacer
5′ spacer frame
5.1, 5.2 pane contact surface
5.4 inner surface of the spacer 5
6 sealing element
7 elastomer profile
8 insulation layer
9 RFID transponder
9.1 dipole antenna
9.1.1, 9.1.2 first or second antenna pole
9.2 dielectric carrier element
10 coupling element
10′ region of the coupling element 10
10.1, 10.1′ projection
10.1K, 10.1K coupled region
12 inner region
13 outer region
14 end face of the insulating glazing unit 1 or of the glass panes 4a, 4b
15 coupling region
16 edge of the coupling element 10
17 center of the dipole antenna 9.1
18 outer surface of the glass pane 4a or 4b
19 inner surface of the glass pane 4a or 4b
20 corner of the glazing unit
20.1, 20.2 first or second corner
90.1 slot antenna
90.1.1 slot, slot-shaped cutout
90.1.2 main body, foil
90.2 RFID electronics
100.1, 100.2 strip-shaped region, strip
arrow A plan view direction or viewing direction
arrow B plan view direction
Pos1 position according to the invention
Pos2 position according to the prior art
A distance
c0 vacuum speed of light
D distance
D1, D2 first or second distance
fₑᵢₙ irradiated frequency
f operating frequency of the RFID transponder 9
L length
BG width of the main body 90.1.2 of the slot antenna 90.1
BS width of the slot 90.1.1
BR width of the (edge) strip 100.1,100.2
DG thickness of the main body of the slot antenna 90.1
LG length of the main body of the slot antenna 90.1
LD thickness of the main body 90.1.2
LS length of the slot 90.1.1
LR length of the edge
lambda vacuum wavelength
P turn-on power
U projection
V offset

1. A glazing, comprising:
a frame made of a metallic first frame element, a metallic second frame element, and a polymeric third frame element connecting the metallic first and second frame elements at least in some sections,
a glazing unit arranged in the frame, and
at least one RFID transponder having a dipole antenna or a slot antenna and an operating frequency f,
wherein
the frame surrounds end faces of the glazing unit and, at the same time, covers the at least one RFID transponder in a viewing direction through the glazing unit,
a distance D between a center of the dipole antenna or a center of the slot antenna and a nearest adjacent corner of the glazing unit is from 40% to 100% of a vacuum wavelength lambda corresponding to the operating frequency f, and
the at least one RFID transponder is arranged on an interior-side surface of the frame.

2. The glazing according to claim 1, wherein the at least one RFID transponder is a UHF RFID transponder.

3. The glazing according to claim 1, wherein the distance D is from 60% to 100% of the vacuum wavelength lambda.

4. The glazing according to claim 1, wherein the dipole antenna or the slot antenna is arranged on a dielectric carrier element.

5. The glazing according to claim 1, wherein the glazing unit includes or consists of a single pane, a composite pane, a fire-resistant glazing unit, or an insulating glazing unit and the insulating glazing unit comprises
at least one spacer, which is formed perimetrally into a spacer frame and delimits an inner region,
a first glass pane, which is arranged on a pane contact surface of the spacer frame and a second glass pane, which is arranged on a second pane contact surface of the spacer frame, and
the first and second glass panes protrude beyond the spacer frame, and an outer region is formed, which is filled, at least in some sections, with a sealing element.

6. The glazing according to claim 1, wherein the at least one RFID transponder is arranged on an interior-side end face of the frame or an interior-side surface of the first or the second frame element that is arranged parallel to large surfaces of the glazing unit.

7. The glazing according to claim 6, wherein the at least one RFID transponder is arranged on the polymeric third frame element.

8. The glazing according to claim 1, wherein the slot antenna has a main body that is a sheet or foil main body.

9. The glazing according to claim 8, wherein the main body has a width BG of 10 mm to 80 mm and/or a length LG of 25 mm to 200 mm and/or a thickness DG of 0.02 mm to 0.5 mm.

10. The glazing according to claim 8, wherein the main body contains or consists of a metallized polymer film or a self-supporting metal foil.

11. The glazing according to claim 10, wherein the metallization of the polymer film has a thickness of 10 μm to 200 μm and the metal foil has a thickness of 0.02 mm.

12. The glazing according to claim 7, wherein the main body has at least one slot.

13. The glazing according to claim 12, wherein the slot has a width BS of 0.2 mm to 20 mm and/or a length LS of 20 mm to 180 mm.

14. The glazing according to claim 1, wherein RFID electronics are galvanically connected and/or electromagnetically coupled to the slot antenna.

15. The glazing according to claim 14, wherein the RFID electronics are galvanically connected and/or electromagnetically coupled to the slot antenna centrally or in an end region or therebetween relative to a direction of extension of the slot.

16. The glazing according to claim 1, wherein the glazing unit has a rectangular shape and has at least four RFID transponders and in each case at least one RFID transponder is arranged at a distance D from a respective corner of the glazing unit.

17. The glazing according to claim 1, wherein the glazing unit has a rectangular shape and has exactly two RFID transponders, which are arranged at a distance D from two corners diagonally opposite relative to the glazing unit.

18. A method comprising providing an RFID transponder as an identification element in a glazing according to claim 1.

19. The glazing according to claim 1, wherein the glazing is a façade glazing, a window, a door, or an interior partition.

20. The glazing according to claim 1, wherein the polymeric third frame element connects the metallic first and second frame elements completely perimetrally.
